(19) United States
(12) Patent Application Publication
(10) Pub. No.: US 2026/0098604 A1
(43) Pub. Date: Apr. 9, 2026

(54) Adjustable Support Stand

(71) Applicant: Michael Stephen Rafferty, Madison, WI (US)

(72) Inventor: Michael Stephen Rafferty, Madison, WI (US)

(21) Appl. No.: 19/209,764

(22) Filed: May 15, 2025

Related U.S. Application Data
(60) Provisional application No. 63/648,170, filed on May 15, 2024.

(51) Int. Cl. F16M 11/22

(52) U.S. Cl. CPC F16M 11/22

(57) ABSTRACT

Embodiments of this inventive technology relate generally to item support apparatus. Although a focus of the inventive technology may, in some embodiments, be on support of musical related items such as keyboards, synthesizers, mixers and effects processing devices, the scope of this inventive technology and its applicability is not necessarily limited as such. The various embodiments of this apparatus provide for enhanced adjustability in width, depth, height, angle, and capacity for an equipment support stand.

### CROSS-REFERENCE TO RELATED APPLICATIONS

This application is a continuation application of U.S. provisional utility patent application No. 63/648,170, filed May 15, 2024, by Michael Rafferty, titled Adjustable Equipment Stand.

### BACKGROUND OF THE INVENTION

Many existing stands, racks, holders and boards are capable of supporting electronic music instruments and other electronic music gear. Stands of this type are typically described as having tiers for holding gear. For instance, a one-tier stand will have support features to hold a single piece of gear. The gear support feature can consist of one or more components. A two-tier stand will have support features to hold two pieces of gear. A three-tier stand will have support features to hold three pieces of gear.

Most of the existing stands provide little or no ability for adjustment. Of the stands that provide for adjustment, the amounts and directions of adjustment are limited. Existing stands are often useful only for a limited range of gear sizes. Existing stands typically do not provide a means for increasing the number of tiers. Taken together, these limitations create a situation where a user is forced to purchase different stands as their collection of gear changes over time.

### BRIEF SUMMARY OF THE INVENTION

This invention is a stand which can hold objects for use, storage, or display on a table, desk, workbench, or on another stand. Other terms for the stand are “rack”, “holder” or “board”. Objects to be held in the stand can be considered to be gear, which could primarily consist of electronic music instruments such as synthesizers, music keyboards, drum machines, drum pads, MIDI controllers, audio processing devices, audio effects pedals, audio mixers, music production workstations, grooveboxes, modular synthesizer cases, or loudspeakers (sometimes called monitors). Secondarily, objects to be held in the stand could be office or computing equipment such as laptops, tablet computers, digital sketch pads, typing keyboards, smartphones or printers.

The stand is not limited to usage with the gear listed here. Other gear of many sizes and shapes can be held by the stand. Gear to be placed on the stand will typically consist of a housing or body which is generally flat or boxy, with sides that are rectangular or nearly rectangular, with control buttons, knobs, sliders, contact pads and other features on the upward-facing surface. This stand is capable of holding gear that has control features on other faces, such as the sides, ends, or bottom. The stand is not limited to usage with rectangular gear. Components of the stand can be used for the purpose of holding curved gear securely in place.

This invention is an equipment support stand that is adjustable in width, depth, height, angle, and number of tiers. In addition, the carrying capacity of the stand can be adjusted in terms of gear weight and size. Angular adjustment can be accomplished by rotating the entire stand relative the table or desk which act as a resting surface. Additionally, the angle of individual support hooks can be independently adjusted.

This invention is unique because of the adjustable positions of the components, the adjustable orientations of the components, the multiple functions that the components can perform, and the ability for the number of tiers to be increased by adding components.

### BRIEF DESCRIPTION OF DRAWINGS

FIG. 1 Shows three orthographic views, plus an isometric perspective view of a one-tier stand.

FIG. 2 Shows a side view of a one-tier stand that has an additional hook, post bracket, and retainer installed in order to convert it to a two-tier stand.

FIG. 3 Shows three orthographic views, plus an isometric perspective view of a two-tier stand.

FIG. 4 Shows a side view of a two-tier stand that has a hook, post bracket, retainer and supplemental panel installed in order to convert it to a three-tier stand.

FIG. 5 Shows three orthographic views, plus an isometric perspective view of a one-tier stand that does not require side panels.

FIG. 6 Shows an isometric perspective view of the one-tier stand from FIG. 5 with each item identified.

FIG. 7 Shows a perspective view of a one-tier stand with a piece of gear installed.

FIG. 8 Shows a perspective exploded view of components needed for one side of this invention. The telescoping connecting tube assembly is not shown.

FIG. 9 Shows a perspective view of the hook, showing its features.

FIG. 10 Shows four orthographic views, plus two isometric perspective views of the hook extender.

FIG. 11 Shows four orthographic views, plus two isometric perspective views of the Pivot Foot.

### DETAILED DESCRIPTION OF THE INVENTION

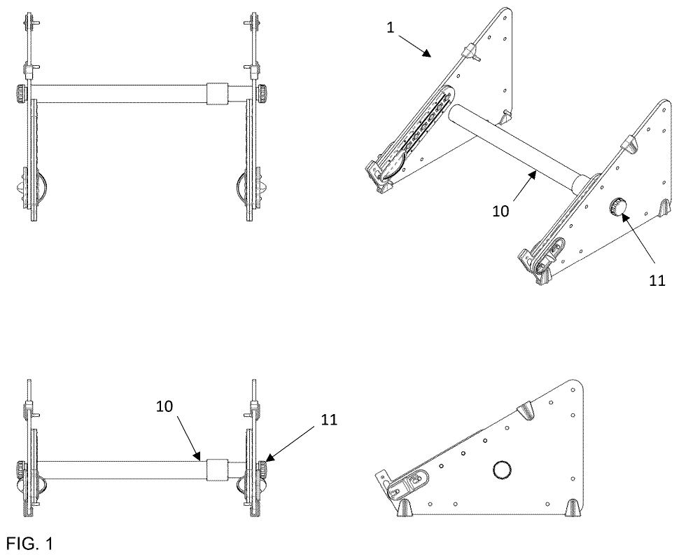

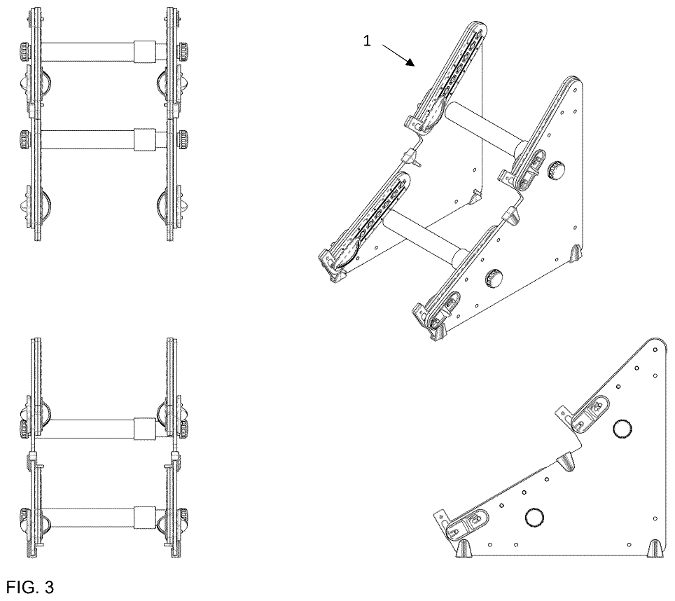

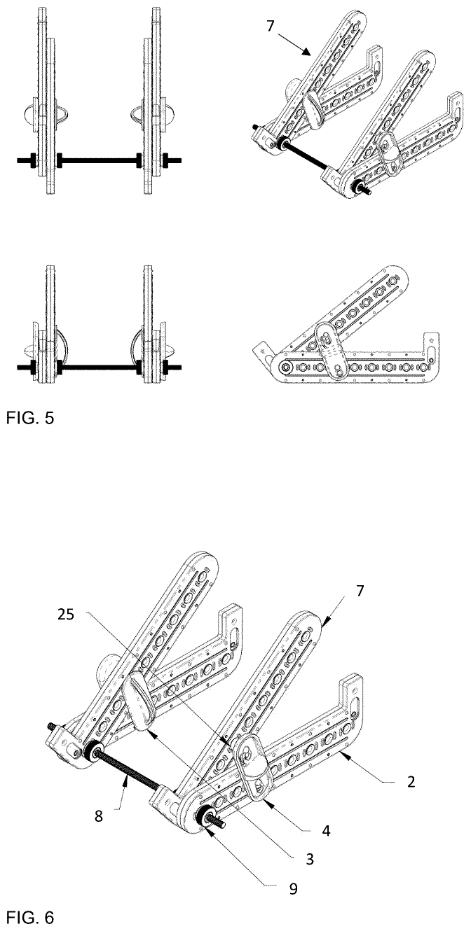

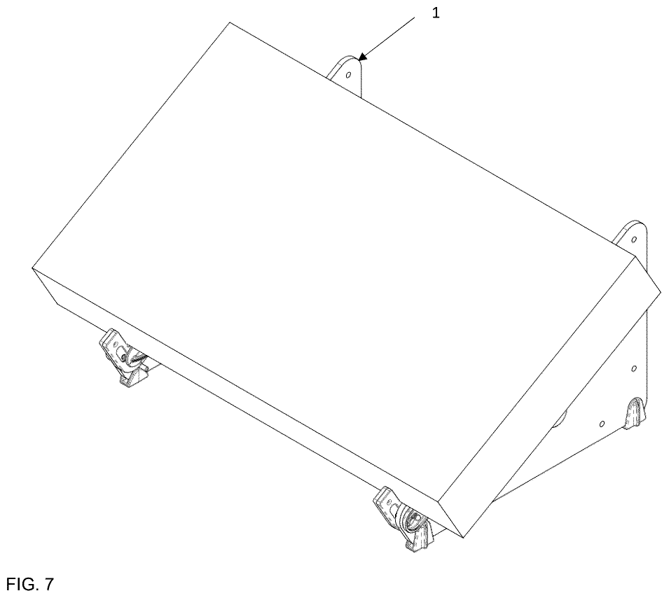

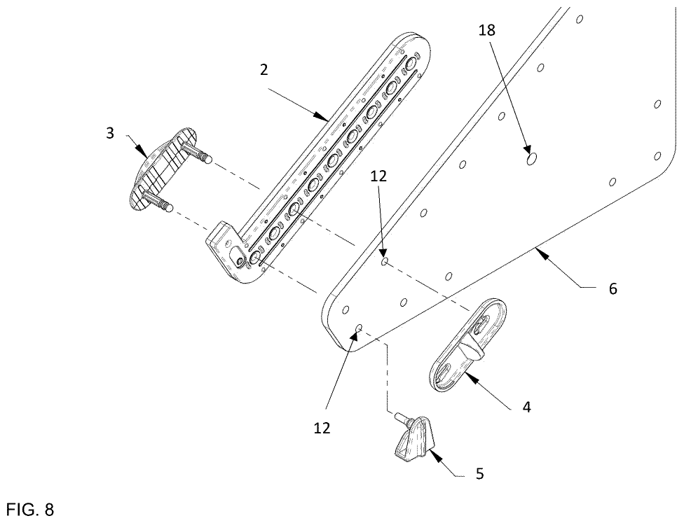

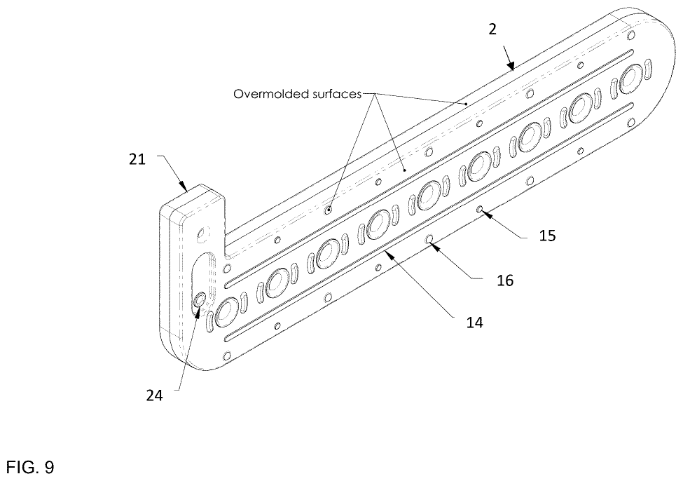

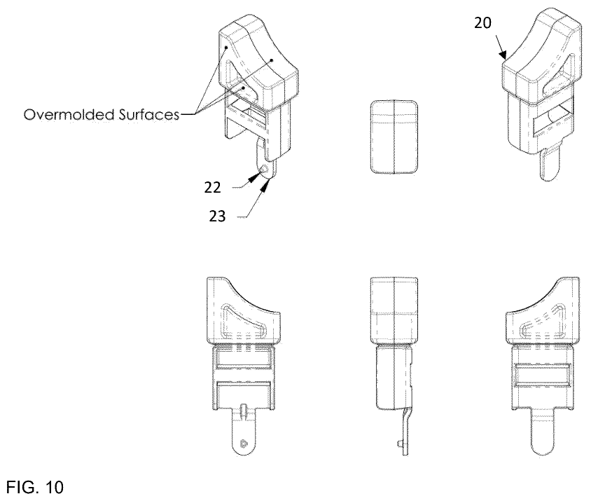

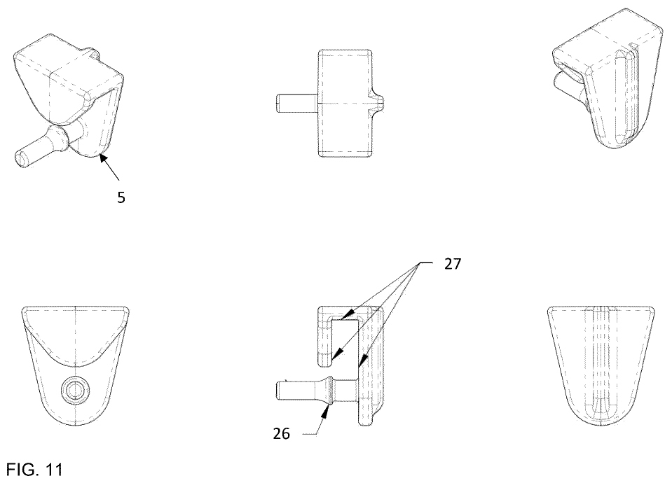

The components of this Stand 1 can be assembled in many different configurations through mechanical joints. Mechanical joints are affixed using posts and retainers, or threaded fasteners. Most components of the Stand 1 have holes and posts of a common diameter and spacing. This allows the components to be moved and substituted on a modular basis. The invention presented here is not limited in the number of tiers it can incorporate. The number of tiers is usually defined by the number of straight edges on the Side Panel 6. See FIG. 1 for a one-tier stand 1, and FIG. 3 for a two-tier stand 1. In this Stand 1, the gear support feature consists of a pair of edges positioned parallel to each other. The edges are primarily attached to the stand's side panels. In one embodiment of this concept, side panels are omitted and the component that contains the gear support edges becomes the framework of the stand (see FIG. 5).

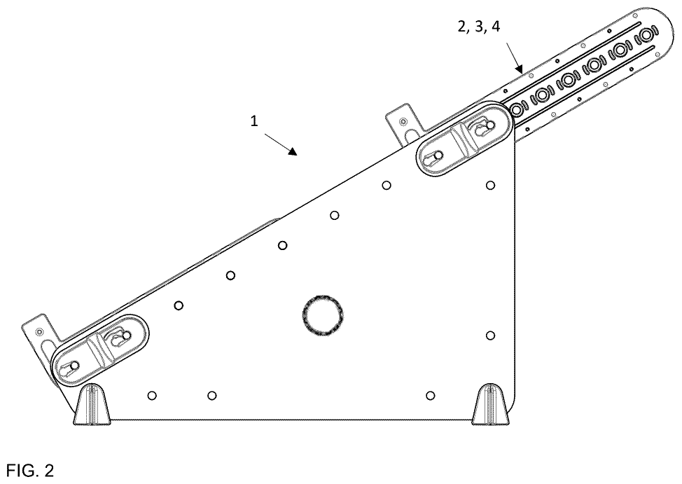

The invention presented here is capable of permitting the user to optionally subdivide a tier into multiple tiers. That is, a one-tier stand can become a two-tier stand if the user installs the appropriate optional components (see FIG. 2).

In most cases, a matched set of components are necessary on the left and right sides of the stand. For instance, the left Side Panel 6 might have two Pivot Feet 5 installed at the bottom front and rear corners, plus a single Hook 2 with one Post Bracket 3 and one Retainer Slider 4. The right Side Panel 6 will typically have an identical configuration of Pivot Feet 5, Hook 2, Post Bracket 3 and Retainer Slider 4. For the sake of brevity, descriptions in this document will only mention the configuration of components on one side of the stand. Unless otherwise explicitly stated, it should be assumed that descriptions in this document apply to matched sets of Side Panels 6 and components on both the left and right sides of the Stand 1.

When optional accessories such as additional Hooks 2 or Pivot Feet 5, are not in use, they can be stored in any empty holes on the Side Panel 6.

A special assembly configuration 7 (see FIG. 5 and FIG. 6) is possible that does not require the use of a Side Panel 6. Connecting two Hooks 2 together, when in conjunction with a Connector Rod 8, allows for two pair of Hooks 2 to function as a stand. No Side Panels 6 are needed.

Depending on locations of attachment for Connecting Rod 8 and the Post Bracket 3, a wide variety of relative angles between the Hooks are possible, from nearly vertical to nearly horizontal. If the connector rod is a threaded rod, then threaded nuts or Thumb Nuts 9 are required. By adjusting the positions of the Thumb Nuts 9 the width of the stand can be adjusted. When the Thumb Nuts 9 are tightened against the stand components, the clamping force secures the components together and the stand is stable.

Unless otherwise noted, all components of this invention, except for the threaded metal screws, nuts, thumb nuts and rods, are intended to be manufactured primarily by injection molding a rigid plastic resin. Alternatively, it is possible to machine the components out of solid plastic resin or metal stock.

The Side Panel 6 is a rigid panel which transmits loads from the Hooks, Connector Tube 10 and Connector Knob 11 down into the Pivot Feet 5. A key feature of the side panel is high stiffness, which is achieved through a combination of modulus of elasticity and material cross section. A thin cross section requires the use of a material with a high modulus of elasticity, such as steel, while a thick material permits the use of a lower modulus material, such as plastic. In the preferred embodiment of this invention, the material is acrylic of thickness of 4.5 mm. Alternatively, adequate stiffness in the side panel can be achieved through the use of structural shapes, such as molded or stamped ribs or channels, which permits use of thin material that could possibly be of a low modulus of elasticity.

Numerous Holes 12 of identical diameter and spacing exist along the edges of the Side Panel (see FIG. 2). The diameter and spacing of the holes match those on the Hook 2. On the edges primarily intended for holding Hooks 2, a large number of Holes 12 exist for the purpose of providing numerous mounting positions for the Hook 2. On other edges, Holes 12 are intended for mounting of the Pivot Foot 5, a Leg Subassembly, or for secondary attachment of the Hook 2 during storage when the Hook 2 is not in use. The Side Panel 6 is primarily intended to be manufactured by machining, routering, or laser cutting flat sheet stock. The sheet stock is primarily intended to be a rigid plastic resin, although other materials such as wood, medium density fiberboard, or metal can be used.

The Connector Knob 11 attaches to the Connector Tube 10 through a Hole 18 in the Side Panel 6. Using mated threaded features, the Connector Knob 11 can be twisted to create a clamping force. This clamping force maintains contact between the Side Panel 6 and the butt ends of the Connector Tube 10 when the assembled Stand 1 experiences a lateral load. Alternatively, the Connector Knob 11 can be replaced with a screw, although it is recommended that the screw be of the flange head type in order to provide stability for the Connector Tube 10.

The Connector Tube 10 can be hollow or solid, and can be of a one-piece rigid construction, or it can be a telescoping assembly with a locking joint between the telescoping pieces. A female threaded fitting in each end of the Connector Tube 10 can mate with a male threaded shaft on the Connector Knob 11.

The Hook 2 consists of a rigid plastic substrate with overmolding. The overmolding is a soft elastomer on nearly all surfaces. The elastomer can be any form of synthetic or natural rubber, a thermoplastic elastomer, or a thermoplastic urethane. The Hook 2 is affixed to the Side Panel 6 through a clamping forced generated by the combination of the Post Bracket 3 and Retainer Slider 4 during product assembly. Alternatively, the clamping force can be generated through the use of a threaded screw and nut. In the preferred embodiment of this invention, the rigid plastic is acrylonitrile butadiene styrene (ABS) and the elastomer overmolding is a thermoplastic urethane.

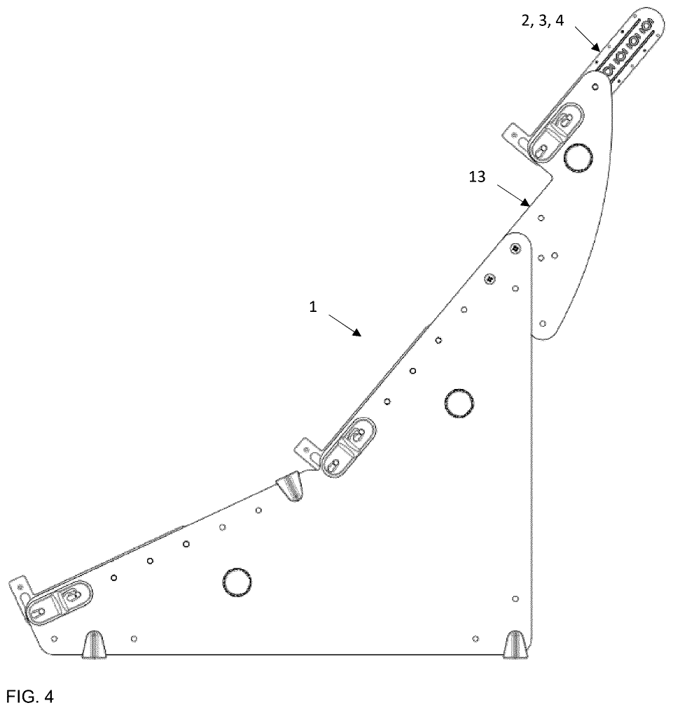

The primary purpose of the Hook 2 is to retain the gear in position on the Side Panel 6. The Hook 2 can be installed in multiple locations and orientations. The Hook 2 can be installed along any edge of a Side Panel 6 that has at least one mounting Hole 12 of the corresponding size. The Hook 2 can also be installed on a Supplemental Panel 13 which can be mated to the Side Panel 6 (see FIG. 4).

A secondary purpose of the Hook 2 is to stabilize the stand in situations where gear is supported by other Hooks 2 and the location of the load is positioned such that an overturning moment could cause the Stand 1 to become unstable.

Another secondary purpose of the Hook 2 is to act as a foot for one corner of a Side Panel. When used for this secondary purpose, the Hook 2 will be attached to two Holes 12 on the lower portion of the Side Panel 6 in order to act as a foot. But it is possible for the Hook 2 to be installed at only a single hole, with the second point of contact for reacting loads to be provided by impingement of one of the posts in the Post Bracket 3 against an edge of the Side Panel 6.

Another secondary purpose of the Hook 2 is to act as a foot for one region of a side panel. This is accomplished by installing the hook into two holes in whichever edge of the Side Panel is facing downwards.

Another secondary purpose of the Hook 2 does not require the use of a Side Panel 6. Instead, two Hooks 2 are mated to each other and to a Connecting Rod 8 (see FIG. 5 and FIG. 6).

A total of four long ribs 14 extend nearly the entire length of the Hook and project above the elastomer. The ribs are exposed in order to allow their height to be maximized to maximize bending stiffness of the Hook 2. A series of round Posts 15 on the two lateral faces extend above the overmolding. These Posts 15 are load reaction points that prevent the Hook from rotating about its long axis relative to the Side Panel when under load from gear which impinges on the upper face of the Hook.

A series of Rounded Posts 16 in the overmolding serve as springs to create an interference fit in the stack of components when the Hook 2 is mated to the Side Panel, Post Bracket and Retainer. Due to variability in the stock thickness of the Side Panels, the Rounded Posts 16 are necessary to provide either a large amount of interference fit or a small amount of interference fit. If the rounded elastomer posts were omitted, the Hooks would be slightly wobbly against the Side Panels when the Side Panel material is thinner than nominal.

A series of Arc-Shaped Raised Ribs 17 in the elastomer surround each mounting hole in the Hook. These serve two purposes. First, they perform the same clamping spring function as the Rounded Posts 16. Second, they act as anti-rotation features to prevent inadvertent loosening of Thumb Nuts 9 are installed for special assembly configurations.

The Hook shape includes a full round end and rounded lower front corner. These permit stable contact with the table or desk at all angular orientations The Hook Extender 20 component consists of a rigid plastic substrate with an overmolded elastomer covering at surfaces that will contact gear. It slides over the Tab 21 on the Hook and can be installed in either of two orientations in order to increase the height of the tab at the face which contacts the gear installed on the Stand 1. This allows for gear with a curved or angled front edge to be securely retained on the Stand 1 without fear of the gear sliding up and over the tip of the Hook tab. The Hook Extender features a small post 22 on a tab 23 which locks the Hook Extender onto the Hook when it's installed onto a Side Panel. The clamping action of the Post Bracket and Retainer prevents deflection of the tab, which prevents the small post from exiting the hole 24 in the Hook Tab. Security of the Hook Extender is important for use during earthquakes or for oversize gear that will impart large loads into the Hook Extender.

The Pivot Foot 5 serves a primary function as a point of contact between the side panel and the flat surface upon which the stand is mounted. Typically, a total of 4 feet will be needed per stand. A secondary function of the foot is to support gear that is longer than the Hook. When used for the secondary purpose, a single Foot is used per Hook. The Foot connects to the Side Panel through an arrowhead post 26. During installation the cylindrical tip of the post is pulled by the user, thus pulling the arrowhead through the hold in the Side Panel. The J-shaped profile 27 of the Foot body serves as a hook to keep the base of the Foot engaged with the Side Panel. The Foot material is soft and grippy solid elastomer. The elastomer can be any form of synthetic or natural rubber, a thermoplastic elastomer, or a thermoplastic urethane.

The Post Bracket 3 component contains two round posts, a base plate, and a flange for gripping. The Post Bracket mechanically mates the Hook to either a Side Panel or to another Hook. Two sets of grooves are present on each post of the Post Bracket. Two slots in the Retainer will mate with two of the grooves on the Post Bracket. Each set of grooves are at a different axial position along the round post of the Post Bracket. One set of grooves corresponds to the position of the Retainer when the Hook is mated to a Side Panel. The other set of grooves corresponds to the position of the Retainer when a Hook is mated to another Hook. (see FIG. 5 and FIG. 6).

The Retainer 4 component has two slots which engage with grooves on the posts of the Post Bracket. After the retainer is slid onto the grooves of the post, the Post Bracket cannot be removed from the assembly. To prevent the Retainer from falling off of the assembly, a snap leg retention bump is included. In order to remove or install the Retainer, the user must push the retainer with sufficient force to overcome the snap leg retention bump. Because of the snap leg, the Retainer is intended to be injection molded from rigid plastic resin, and it is not suitable to be machined from metal.

A Spacer 25 is needed in situations where the Hook, Post Bracket, and Retainer are be used where one or more of the posts do not pass through a Side Panel. A gripping flange is included on the spacer to assist the user during installation and removal, to aid in visibility, and to prevent the Spacer from rolling away when placed on a hard surface.

The Leg Subassembly consists of a Leg Panel, which is of similar construction to a Side Panel, plus a Foot, plus a pair of screws and nuts to secure the Leg Panel to the Side Panel. The Leg Subassembly can be primarily installed at the front and rear corners of the lower edge of a Side Panel. By choosing from a variety of mounting holes, the height of the Leg Subassembly can be varied, which will allow the Stand 1 to be raised above the table. It is possible to use a different height for the front and back Legs, which will result in the Stand being placed at an angle. A secondary use of the Leg Subassembly is as a small brace at the lower rear of the stand to stabilize against a load that is overhanging at the rear. Another secondary use of the Leg Assembly is as a support for the rearmost portion of a piece of gear. This will allow the gear to sit at an angle relative to the Hook.

1. A gear support device comprising two hooks; two dual-pronged post brackets; two post retainers; two side panels; one or more telescoping connector tube assemblies; two or more connector knobs, and two or more pivoting feet.

2. The device of claim 1, wherein the hook has two parallel straight edges joined by a rounded end.

3. The device of claim 1, further comprising a tab projecting upwards from one of the parallel edges of the hook.

4. The device of claim 1, wherein the hook includes one or more bumps per lateral face that can be compressed during assembly for the purpose of creating an axial preload between the post retainer, side panel, and two-pronged post bracket.

5. The device of claim 1, wherein the post retainer comprises a flat plate with one plain elongated slot, and a second elongated slot that has a retainer bump on a snap leg.

6. The device of claim 1 wherein the dual-pronged post bracket comprises a flat plate and two posts, with each of the posts containing one or more grooves which will join with the slots in the retainer plate.

7. A pivoting foot that attaches through a hole in a side panel.

8. The device of claim 7 wherein the pivoting foot is a single body comprised of an elastomeric material.

9. The device of claim 7 wherein the front profile of the pivoting foot is J-shaped.

10. The device of claim 7 wherein the pivoting foot includes an arrowhead-shaped post.

11. The device of claim 7 wherein the pivoting foot must be distorted in two locations in order to permit its attachment to the side panel.

12. The device of claim 7 wherein the distortion of the pivoting foot includes a reduction of diameter of the arrowhead when its tip is pulled, and where the J-shaped profile is deflected in order to fit around the edge of the side panel.

13. The device of claim 7 wherein the side panel is optionally shaped so that the hole is located concentric to a rounded corner of the side panel so that the pivoting foot can be rotated into position on either of the two adjacent flat edges of the side panel.
